(19) United States
(12) Patent Application Publication
(10) Pub. No.: US 2018/0004850 A1
(43) Pub. Date: Jan. 4, 2018

(54) METHOD FOR INPUTTING AND PROCESSING FEATURE WORD OF FILE CONTENT

(71) Applicants: Erzhong LIU, Beijing (CN); BEIJING QIHOO TECHNOLOGY COMPANY LIMITED, Beijing (CN)

(72) Inventor: Erzhong LIU, Beijing (CN)

(21) Appl. No.: 15/702,534

(22) Filed: Sep. 12, 2017

Related U.S. Application Data
(63) Continuation of application No. 14/582,856, filed on Dec. 24, 2014, now abandoned.
Application No. 14/582,856 is a continuation of application No. 13/384,592, filed on May 2, 2012, now abandoned.

(30) Foreign Application Priority Data
Jul. 17, 2009 (CN) 200910158038.0
Nov. 11, 2009 (CN) 20091020806.2

(51) Int. Cl. G06F 17/30

(52) U.S. Cl. CPC G06F 17/30867; G06F 17/30616; G06F 17/30705

(57) ABSTRACT

A computer or computer retrieval system implemented method for inputting and processing file feature determination information by network terminal users. It includes providing terminal users with the items of the files according to query, determining the input feature word(s) according to the prescribed operation modes and the prescribed modes on the web page on which the item sequence(s) being located or a web page linked by that web page directly. Retrieval system can process the input information to create or improve a retrieval method or database used by users which can include different feature words or classification results, therefore the search efficiency would be greatly improved

### CROSS REFERENCE TO RELATED APPLICATION

This application is a continuation of U.S. application Ser. No. 14/582856, filed Dec. 24, 2014, which is a continuation of U.S. application Ser. No. 13/384,592, filed May 2, 2012, which is a national stage application of International Application No. PCT/CN2010/074197, filed Jun. 22, 2010, which claims the benefit of Chinese Patent Application No. 200910158038.0, filed Jul. 17, 2009, and Chinese Patent Application No. 20091020806.2, filed Nov. 11, 2009, the entire contents of which are incorporated herein by this reference.

### FIELD OF THE INVENTION

The present technology belongs to computer retrieval technology or search engine technology.

### BACKGROUND OF THE INVENTION

Over years, there is great development in the technology of computer database retrieval, especially the development of network technology, which makes the scale of the database that could be shared by people achieves an enormous figure. But is also brings great difficulties for people who searches for the required information.

Search engine technology which regards query word searching as the core has brought convenience to users. The system can obtain keyword search request via an interaction interface on users' computers as well as via a communication network, query in a text index database and make correlation analysis between the keyword request and the text, obtain the related result and rank it, which then be provided to the interaction interface via the communication network or route. This kind of search system is very convenient and quick for use, but the amount of the index which is included in the return results is very huge and hard to be looked up one by one.

In order to rank the most valuable query result in the front pages, the U.S. Pat. No. 6,285,999 has provided a structural analysis based on web page hyper link (Page links) to conduct the technology of ranking search results, which outperformed all the other ranking technologies and obtain an unprecedented success. This technology, as well as all kinds of other ranking technologies, only improves the efficiency of query word searching statistically, however, cannot guarantee all the wanted query results being ranked in the front of a huge items table. Before reading the expected information, we often read a variety of irrelevant information with the main content being repeated over and over.

For the user' convenience to find the desired information or files, people also seek help from vertical classification technology and the catalogue retrieval system based on the technology. To classifying massive information or determine features, there are all kinds of text classification methods of computer. However, it is very difficult for machine to determine whether one page or text belongs to which one or several items of semantics or feature or classification of a certain key word, the reliability and accuracy is low, particularly in the multi-layer classification, the error ration is too high to be tolerated. Therefore, computer classification is only used for the simplest rough classification, such as determining whether the network file is a “web page” or “map” or “mp3”, etc., according to the occurrence frequency or format feature of a quantity of phases.

Currently, vertical classification technology with high accuracy cannot function without human intervention. For example, in the 1990′s, artificial information classification system of Yahoo and so on can only take very small part of the online information classification processing. Others like all kinds of a finite number of professional classification information of for example, “Baidubaike”, “Wikipedia”, “taobao.com”, “Alibaba” are all through their special database platform respectively, collected by registered members or registered users or website staff in accordance with specialized rules aiming at certain range of entries, wherein the included appending classification content can only aim at the entry or text of its own database. To the users of non-specific online database content, so to speak, the help is very limited when searching.

Lichan Hong (US-20080201651) has provided a method about “making words within the document selectable” in favour of more search, but it is useless to search in accordance with category or classification too.

Consequently, there is an active demand for a new technology by Internet users, which makes computer retrieval system or search engine system can not only provide to users with hundreds of millions of bibliographic information of web pages in thousands different websites, but also can determine the accurate feature or multi-layer feature or category for web pages originating from numerous different websites, and provide a query result with great improvement on accuracy and affinity. For this reason, there is an urgent need for a convenient technology for collecting and processing for web page feature determination opinion.

### SUMMARY OF THE INVENTION

The purpose of this invention is to provide a method for computer retrieval system or search engine system, which provides an item sequence of query results about query words for internet terminals or users, and may allow the convenient input of feature words (classifier or key word) determined by users or staff for related files originating from different websites or database, and process the input information to create a retrieval method or database used by users which includes different feature words or classification results, therefore the retrieval or search efficiency would be greatly improved.

This invention is a computer or computer retrieval system implemented method for inputting and processing “file or item classification determination information” by network terminal users, and using the information to search files or items in accordance with classification later, which includes operation A and operation B and operation C:

Operation A: according to query request(s) by terminal user(s), providing terminal users with the files (sequence(s) of files' items) which are formed by the computer retrieval system based on files sourced from websites or database of the computer retrieval system.

The item, i.e. “item of file” or “file's item”, can be a part of the file, or the topic or the abstract or the topic with the abstract of the file; “file or item classification determination information” is the information of classification about the file or item; the “feature word” is classifier or/and key word.

The computer or the computer system or the computer retrieval system can be a computer search engine system or a part of them or not.

The inputting and processing method also comprises:

Operation B: determining the input classifier or key word according to one or more prescribed operation modes on the web page on which the items being located or a web page linked by that web page directly;

The prescribed operation mode can be cursor click operation mode or word input operation mode.

The prescribed operation mode can be one of the following:

operation mode 1: choosing the word(s) as the input feature word(s) (classifier or key word), which being selected by cursor clicking from a list of feature words (classification list or list of key word) to be selected, the list being presented on the web page on which the said item sequence(s) in operation A being located or presented on a web page linked by that page directly, the classification list consist of classifier(s) or key word(s) predetermined by the computer retrieval system and can be independent of the word(s) in item(s) on the web page;

operation mode 2: setting feature word input field(s) (classifier or key word input field(s)) on the web page(s) on which the said items in operation A being located or web page(s) linked by that web page(s) directly, determining the input feature word(s) (classifier or key word) according to the input content in the input field.

Wherein, the input content of the feature word input field (classifier or key word input field) may from typing, or from a copy-paste.

When needed, for the purpose of simple and direct operation, the feature word input field can be limited to present only on the web page on which the items (item sequence(s)) being located.

The said feature words (classifier or key word) can be one or more words or phrases, which can be selected by terminal users or other people and regarded as reflecting the feature or classification of corresponding items or file contents. The items or file content is the content of the items or file. The said words could be characters or symbols or notes or figures.

The said input field refers to the space or location on a terminal page for inputting or filling in words. It can be an entry bar.

The said computer or computer system could be the computer retrieval system or retrieval system or component of them.

The said terminal user could be a web user or a web page writer or a web page provider, or staff from a network or a search engine company.

The files could be documents or web pages or part of web pages or the transferred contents (like the snapshot of web pages) of a retrieval system or other computer system.

The item can contain image content or audio content or video content.

The inputting and processing method also comprises:

Operation C: determining the item(s) or file(s) corresponding to the input feature word(s) (classifier or key word) according to one or more prescribed modes on the web page on which the item sequence(s) being located or a web page linked by that web page directly;

The said prescribed mode can be cursor click determine mode or location determine mode.

Wherein the said prescribed mode is one or more of the following:

mode I: determining the clicked item(s) or file(s) as the item(s) or file(s) corresponding to the input feature word(s) (classifier or key word); mode II: determining the item or file around the clicked “feature word (classifier or key word) determination operation indicator” as the item or file corresponding to the input feature word(s) (classifier or key word). mode III: determining the item or file as the item or file corresponding to the input feature word(s) (classifier or key word), which is the nearest to the input field on the web page on which the feature word input field (classifier or key word input field) being located or on the prescribed direction of the input field; mode IV: determining the only item or file on the web page on which the feature word input field (classifier or key word input field) being located as the item or file corresponding to the input feature word(s); mode V: determining the item or file as the item or file corresponding to the input feature word(s) (classifier or key word), which is the nearest to the list of feature words (classification list or list of key word) to be selected or the located on the prescribed direction of the list on the web page; mode VI: determining the only item or file on the web page on which the said list of feature words (classification list or list of key word) to be selected as the item or file corresponding to the input feature word(s) (classifier or key word). The item(s) or file(s) corresponding input classifier(s) or key word(s), could be included in the result of searching the corresponding input classifier(s) or key word(s) in accordance with classification later.

In the operation C, the input feature word(s) refers to the feature word(s) which had been inputted or is being inputted or will be inputted.

The order to prioritize operation B or C can be determined based on need.

The operation B can be executed before operation C or after operation C or with C simultaneously.

We can refer to the feature word(s) (classifier or key word) which is corresponding to a certain item(s) or file(s) as the feature word(s) (classifier or key word input field) belonging to the item(s) or file(s), or the feature word(s) (classifier or key word) corresponding to the item(s) or file(s), or the feature word(s) (classifier or key word) of the item(s) or file(s).

Among the methods mentioned above, the same file or the item thereof can be allowed to have many different classifiers simultaneously; the same feature word can belong to many different items or files simultaneously.

It can be generally acknowledged that, the feature word for one item should be the same as the feature word of the item's file.

The said feature word(s) can be the key word reflecting the content feature or classification or different layer classification of the corresponding item or file, the said “feature word input field” also can be the “key word input field”.

The said feature word(s) can be the classifier reflecting the content classification of the corresponding item or file, or the classifier which reflects different layer classification in the multi-layer classification system, the said feature word input field also can be the “classifier input field”.

In the said inputting and processing method, on the web page on which the said item sequence(s) is located or a web page linked by that web page directly is set with an appending list of the feature words (classification list or list of key word) to be selected.

“The web page or list directly linked by a web page”, it means that the page or list linked by the web page on which the items is located or an operation indicator of the feature word determination (an operation indicator of classifier or key word determination) or a list title or a hint or other word items or the web page or list linking to content.

The list of feature words to be selected can be the classification list which includes many different classifiers. The said list of feature words to be selected or classifications can be single-layer list or multi-layer list or tree catalogue.

It can be arranged that: among the classification list mentioned above, the next layer classification items (classifiers) belonging to the previous layer classification item (classifier) can automatically display before or after the previous layer classification item (classifier) is clicked.

In this method, the input field can be input with feature word(s) by the means of allowing cursor clicking or brushing the desired word(s) in the said list setting.

Obviously, the input feature word in this method is the determination information to the related item or file feature which is input by a clicking manipulator on the terminal or the feature word corresponding to the information.

This method can also include: the related computer system can accept or refer to or process or deny the feature determination opinion(s) or feature word(s) or classifier(s) input by terminal users in its database.

The inputting and processing method of the invention can also include: the principle need to be followed may at least be considered about one or more of the following factors when the said computer system or database determines the input feature words or classifiers corresponding to any one item or file according to the terminal user input opinion:

(1) the similarity between the name of the user who makes determination or the URL of the website and the name of the file provider or author of the file or his URL or the URL of the file;

(2) the number of the users who make the same determination;

(3) the time when a determination is made;

(4) the accuracy assessment or score on user's previous determinations made by them or from their URL;

(5) the consistency between the choice of the feature words and the result of other manual selection methods or computer selection methods or selection systems;

(6) whether the determination is made by the retrieval system operator or staff or the like;

(7) whether the user or the terminal who makes determination has registered in the website or web page which is relevant to the feature word determination or selection.

The above-mentioned method is actually aimed to help users determine the feature words on the files or items from search engine websites. Once the determination information has been accumulated to a certain quantity through a period of time, it can help searching systems or search engines or computer systems set up a feature words or classification words database or an applicable search tool; it can also improve the rankings of files or items in any search results.

The method can also include: according to query request(s) by terminal user(s), it can provide terminal with the items (items sequence(s) of the files), wherein the rank in the sequence(s) for one or more items at least partly depends on whether the file(s) or the item(s) has been determined with any feature words.

The method can also include: according to query request(s) by terminal user(s), it can provide terminal with the items (the items sequence(s) of the files or sequence(s) of files' items), wherein the rank of the items at least partly depends on the importance of one or more feature words of the file(s) or the item(s), the feature words of the file(s) or the item(s) can be the name(s) of the author of the file(s) or the item(s).

The importance of feature words of the file(s) or the item(s) depends on the online popularity of the file(s) corresponding to the feature words

The method can also include: according to query request(s) by terminal user(s), it can provide terminal with the items (the items sequence(s) of the files or sequence(s) of files' items), making the different files or items owned by different authors or with different feature words to be equally distributed in one or more part of the item sequence(s) of search results.

Therefore, this method can also include an operation D1:

the retrieval system generates a database which contains the content of the feature words corresponding to multiple files or items, or the content of the files or items classified by the difference of their feature words, wholly or partly according to the data of the feature words determined by the said method that corresponding to the files or items.

The method of the present invent can also include an operation D2: the retrieval system generates a feature word index or a classifier index or a classification index of multiple files or items, which is wholly or partly according to the data of the feature words corresponding to multiple files or items that is determined by the said method, or the database created in the operation D1 which includes content the feature word of multiple files or items or the classifiers.

The said classifier index refers to that the index can be used to retrieve or access to or link the file(s) corresponding to the feature word(s) or the items or the address or the related information thereof according to any one feature word selected.

The said classification index can be refer to that the index can be used to retrieve or access to or link the file(s) corresponding to the classifier(s) or the items or the address or the related information thereof according to any one classifier selected.

The inputting and processing method of this invention can also include: other original classification or the classification index of the multiple files can be replaced or revised by the classification or classification index of the feature words of the multiple files by using this method.

The method of this invention can also include: when receiving query, the retrieval system provides the retrieval or search result satisfying the needs of the applicable feature word or classifier by using or not using the said feature word index or classification index. The result can include item(s) or item sequence or list or tree catalogue.

The inputting and processing method of this invention can also include: when receiving query, the retrieval system obtains or provides the retrieval or search result satisfying the needs of the applicable feature word request or query request by using the said feature word index or classification index and the query word index or key word index used by the computer retrieval system when processing the query request provided by the terminal user. The result can include item(s) or item sequence or list.

The inputting and processing method of this invention can also include:

Operation E: when providing search services, the computer retrieval system provides item sequence of multiple files to a user terminal according to the query request by a network user; around each item of the whole or part of the said items (item sequence), there can be one or more “feature word indicator(s)” (indicator of classifier or key word) respectively for one or more feature words that belong to each item or its file.

The said feature word indicator can be the feature word or the indicator containing the feature word.

The method allows increasing or decreasing or replacing the said feature word indicator(s) according to the operation of the terminal user.

The said “feature word indicator” can be the indicator reflecting the key word of the content feature of the corresponding item or file, or the indicator of the key word presented in the corresponding item or file, when needed, the indicator of the key word is allowed to present in the said item in operation E.

The said feature word indicator can also be a classifier indicator, or a classification indicator of a single-layer or a multi-layer classification system.

The inputting and processing method of this invention can also include:

operation F: the said feature word indicator around the said item in operation E can be respectively linked to its derivative items (derivative item sequences of multiple files or sequence(s) of multiple files' items), the feature word of the said feature word indicator is as same as the feature words of the part or the whole items in its derivative item sequences.

When needed, the whole or some of the items in the linked derivative items in operation F or the files which the item belongs to, also need to satisfy the query request originally submitted by the said user in operation E.

The said indicator can firstly be linked to the query search, in which added the feature word or the corresponding classifier or the keyword of the indicator as a query word to the original query word, and thus obtain the demanded item sequence.

The said indicator can also be firstly linked to the query search, which regard the feature word or corresponding classifier or keyword in the indicator as the further query logical requirement in accordance with classification on the basis of the original query, and thus obtain the demanded items.

When needed, the item(s) presented in the original query result sequence while not presented in the derivative item sequence can be arranged to follow the derivative item sequence.

Obviously, around the item(s) in the said new obtained derivative items corresponding to the feature word, there can also be the multiple different feature word indicator(s) or classification indicator(s) or keyword indicator(s) belonging to the item or the corresponding file, it can also be made that the feature word indicators or classifier indicators or keyword indicators belonging to the file which belongs to the item therein, links to the other derivative items related to these indicators, and the rest may be deduced by analogy.

The inputting and processing method of this invention can also include an operation G: around the item sequences of the multiple files (sequence(s) of multiple files' items) provided by the computer retrieval system to the user terminal according to the query request submitted by the network query user, there is a navigation list composed by the multiple feature word indicators, each of the feature word indicators can link to its derivative items respectively, at least one respective feature word which belongs to whole or some of the items in the said linked derivative items (item sequences), can be the same to the feature word in the original feature word indicator linked to the items.

When needed, the whole or some of the items in the said linked derivative item sequence of the other multiple files (sequence(s) of multiple files' items) or the corresponding files in operation G, may also need to be applicable to the query request originally submitted by the said query user.

The said feature word indicator of the navigation list can be the key word indicator of the key word reflecting the content feature of the corresponding item or file, or the indicator of the key word presented in the corresponding item or file, or the classification indicator. The said feature word indicator can be the feature word or the key word or classifier.

The said navigation list can be a single layer list or a multi-layer list. It can be allowed to automatically display multiple feature word indicators in the next layer to be selected after determining the selection of the feature word of the upper layer of the list.

The method is allowed increasing or decreasing or replacing the feature word indicators of the list according to the operation of the terminal user.

The method is also allowed to provide the feature word indicator or navigation list around the item or the derivative items (item sequence) linked or displayed by operation F and operation G to be linked or clicked to display updated result of the other item sequence.

The said file can be web pages. The said file or the said item can include character content and can include image content or audio content or video content.

The method of this invention provides a solution that can essentially solve the problem of determination of the feature word (classifier or key word) of millions web page from millions of different websites that can be collected by a search engine system. Any web users even network system staff, especially the web page provider or author or promoter can conveniently and quickly determine or input the feature word (or key word or classifier) of a file by using the techniques in the present invention when they found the file or item related to their own benefits or interests in the item sequence of the search result by a query search engine. The web page with multiple accurate feature words (classifier or key word) can be searched with priority more easily. Therefore, the valuable web pages may mostly be determined with the feature words by the relevant web page provider or author or web users or technical staff. The method of this invent can guarantee that the input opinion of the people related to the file can be adopted with priority. For instance, we intend to search for pictures for ‘Michael’, after normal search, thousands or millions of pictures appear. However, the majority of those pictures as a result of search do not contain sufficient text message for us. Therefore, the above-mentioned existing methods or prior arts are ineffective. On the contrary, the method of the invention makes great sense in this scenario. Every ‘Michael’ can label their own picture with their individual classification information on the web page including the item of the picture, after processing the accumulated information through search engine, when we or others search for picture for a particular ‘Michael’ later, then we can easily and accurately find the right ‘Michael’ through input the query word—Michael and appropriate classifier or tag (key word).On the basis of the present invention, the search engine system can provide high quality of feature word retrieval services for a significant portion of high quality web pages, even the multi-layer retrieval service, and obtain search results with high centralization or high concentration, greatly increase the search efficiency of the massive web users and solve the difficulties puzzling the web users, therefore, there is significant practical value and effect.

### BRIEF DESCRIPTION OF THE DRAWINGS

FIG. 1 is the illustration for the applicable environment of the embodiments of the present invention.

FIG. 2 is an illustrative chart for the feature word (classifier or key word) input on the item sequence page in an embodiment of the present invention.

FIG. 3 is an illustrative chart for the corresponding feature word indicators (key word indicators) attached to the item or the file it belongs to and navigation list in the page of the item sequence of the search result by user query in an embodiment of the present invention.

FIG. 4 is an illustrative chart for the corresponding feature word indicator (multi-layer classifier indicator) and navigation list attached to the item or the file it belongs to in the page of the item sequence of the search result by user query in another embodiment of the present invention.

FIG. 5 is a flow block diagram for the implementation method of an embodiment of the present invention.

### DETAILED DESCRIPTION OF THE EMBODIMENTS

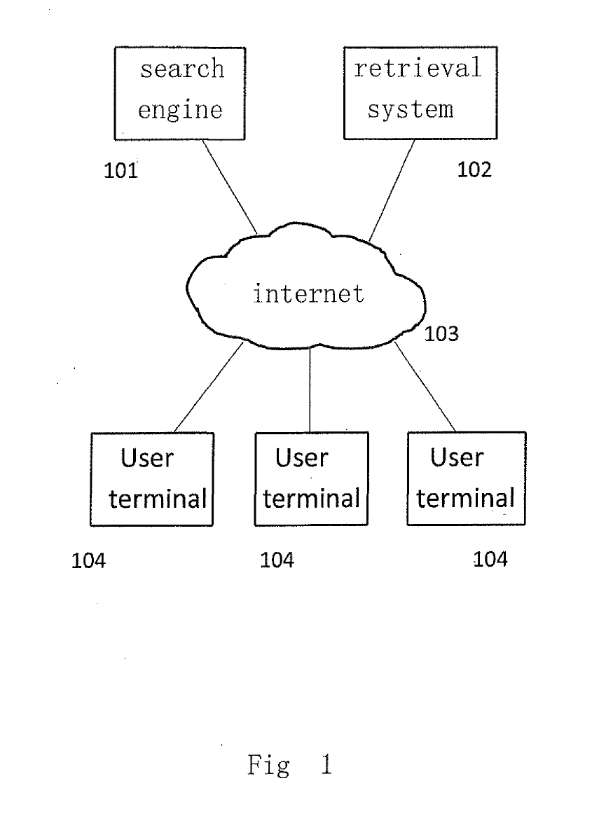

The embodiments of the implementation method are illustrated by reference to the drawings. Wherein, a search engine system 101 is one specialized type of a computer retrieval system 102. They are communicated with user terminal 104 via an Internet 103 (see FIG. 1).

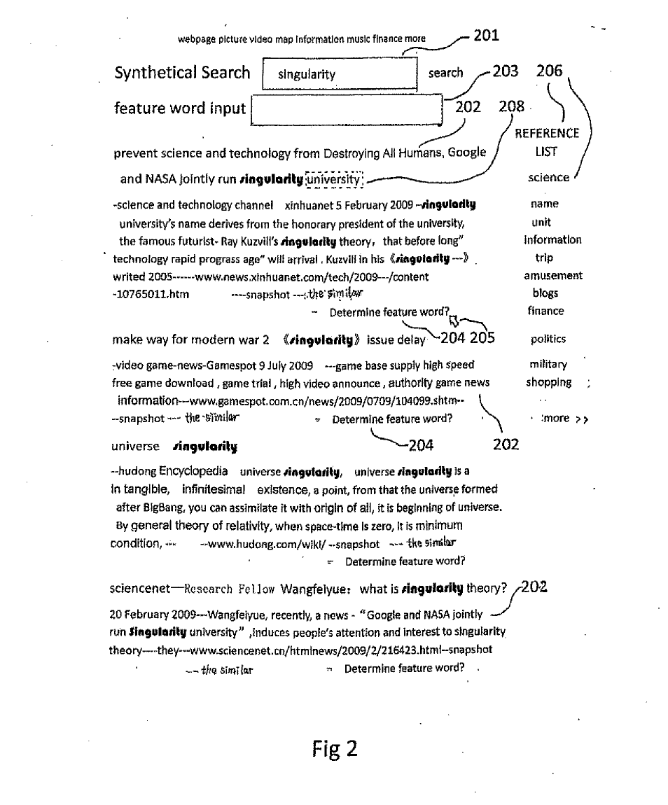

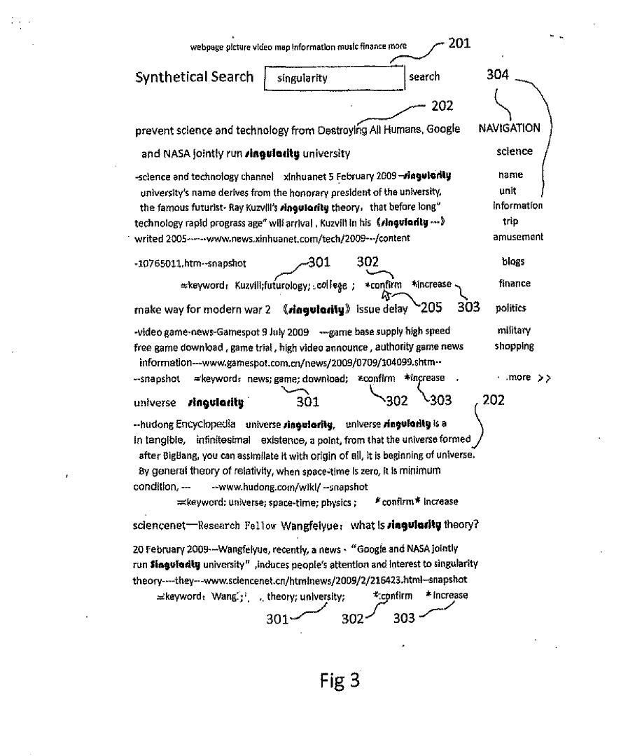

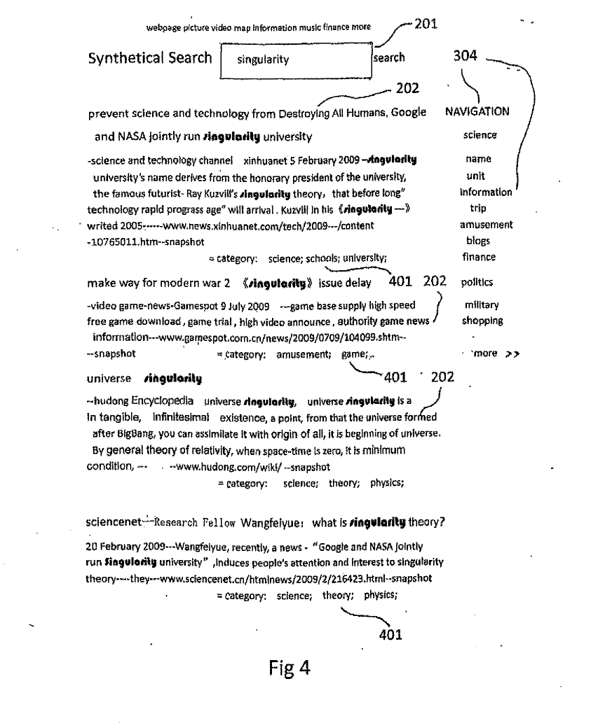

In the embodiments of the FIG. 2, FIG. 3, FIG. 4, 201 is the query field for inputting query word (classifier or key word), 202 is item (item of topic and abstract), 203 is the query field for feature word (classifier or key word), 204 is a feature word (classifier or key word) determination operation indicator, 205 is a cursor of a mouse device operation, 206 is a reference list of feature words (reference list of classifier or key word), 301 is an indicator of the feature word (key word), 302 is a selection operation indicator, 303 is an operation indicator for adding word, 304 is a navigation list; 305 is an input field for input the query about classifier or key word; 401 is an indicator of the feature word (classifier indicator).

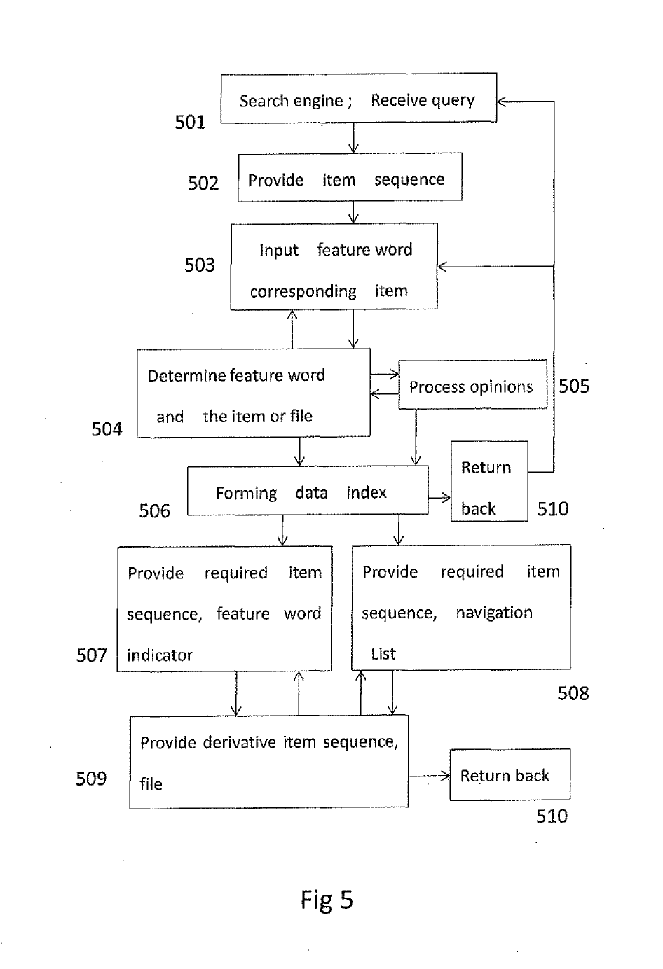

In the embodiments of the FIG. 5,

flow 501: search engine system received query requirement from users;

flow 502: providing an item (topic and abstract) sequence;

flow 503: inputting the feature word (classifier or key word) and determining the corresponding item or file;

flow 504: determining the feature word (classifier or key word) of the item or files according to the input;

flow 505: processing different input opinions;

flow 506: forming the data, index for the feature word of files;

flow 507: providing the required item sequence and the feature word (classifier or key word) indicator around each of the item;

flow 508: providing the required item sequence and a navigation list;

flow 509: providing the required derivative item sequence and file;

flow 510: return back.

To implement the present method, e.g. it should be started with the operation A; firstly, the related retrieval system or search engine system received query request in the query field 201 from network query users or terminal users (flow 501) to provide query searching service to user terminals, which is to provide a sequence made of or partly made of the items of the files (the items of topic and abstract of the files) 202, which is formed by the related retrieval system or search engine system and corresponds to the query request. The files can be from multiple website or database of the related retrieval system or the search engine system (flow 502).

The said file(s) can be web pages, as well as can include character content and can include image content or audio content or video content.

The item(s) can be the topic or abstract or topic with abstract or part of the content or the transferred content of the file, such as a web page snapshot, a caching web page, etc.

The item of the said file can also include different kinds of content, e.g., the abbreviation content of an image, a segment of syllable or score, or a segment or abbreviation content of an audio or video, or a screenshot or a screenshot partial picture.

The method of the present invention has very significant meaning to create the classification or classification index of the web page or file of image content or audio content or video content.

The present method also needs to perform the operation B and C (flow 503).

the operation B: the computer system determines the feature word (classifier or key word) input by terminal users.

The said feature word (classifier or key word) is a word that determined or inputted by terminal users, which can reflect the feature of the corresponding file or item of topic or abstract or file e.g. key word or classifier, it can also be character(s) or symbol(s) or note(s) or figure(s) or figure mark(s), when needed, for example, it can be a syllable or a score segment relating to an audio file or a video file.

There are some embodiment operation modes for determination of the input feature word (or the key word or classifier).

A mode for determination of the input feature word is to regard the word selected by cursor clicking in the feature word list (classification list or key word list) 206 (e.g. the “reference list” 206 in FIG. 2) that presented on the web page on which the said item sequence is located or a linked page or in the feature word list (classification list or key word list) linked directly by the web page as the input feature word (classifier or key word).

The page or the list linked directly by a page, is the page or the list linked by an item or a feature word (classifier or key word) determination operation indicator or a topic or indicator of list or other word or content on the page on which the item sequence is located.

When needed, the list of the feature word to be selected will appear on the web page when the terminal web page is in the feature word operation status or in other time.

Another operation mode is setting “feature word input field” (classifier or key word input field) 203 or an input box on the web page on which the said item sequence is located or a web page linked by that web page directly, the computer system determines the input feature word according to the input content in the input field. The input content of the feature word input field could be from typing, or from a paste of part of the words on the web page on which the said item is located or a web page linked by that web page, or can be allowed to input the feature word to the said input field 203 by means of the cursor click or brush in the item or file or the list of the feature word to be selected.

The feature word (classifier or key word) input field can be the local space near the indicator or hint word (e.g., “feature word inputting” or “feature word” or “key word” or “classification”) on the web page. The feature word input field can also be the query field on the web page, it can also be configured with a graphic selection key for the corresponding feature word input or query input.

It is needed to make the terminal web page staying in the feature word operation status, which can be presented by the query system, or by the clicking selection of terminal users. When needed, it also can be prescribed that when the operation indicator 204 of the feature word determination on the web page or the list 206 of the feature word to be selected or the feature word input field 203 is being clicked or with the input content, the terminal web page enters or stays in the feature word operation status.

The so-called selecting click can make the cursor in clicking status to slip over the related word, or can be the other prescribed operation modes. When implementing in embodiments, it is better to cooperate with clicking “the feature word determination operation indicator” (classifier or key word determination operation indicator) 204 before or after, or make the terminal page staying in the feature word (classifier or key word) operation status by other means to benefit the computer identification

The said “feature word (classifier or key word) determination operation indicator” (called operation indicator for short) means by using which to receive a click to enter into a feature word operation mode, or to indicate the item or file corresponding to the feature word (classifier or key word), or to link the feature word list (classification list or key word list) to be selected. The operation indicator can be the character or indicator or figure or graphic key of other related operation, such as the word sample like “determining feature word” 204 or “linking feature word list” or “classification operation indicator” or “participating in classification”, etc. in FIG. 2.

It is also needed that the computer system determines the item (items of topic or abstract) or file corresponding to the input feature word according to one of the following modes on the page on which the said item sequence is located or a web page linked by that page (operation C) (flow 503).

Specifically speaking, the mode I can be used as: the item 202 or file in which the word 208 selected by the said cursor clicking in one operation mode 1 in operation B is determined to be the item or file corresponding to the input feature word.

Or mode II: the item or file being clicked is determined to be the item 202 or file corresponding to the input feature word. It's better for the terminal page to stay in the feature word operation status.

Or mode III: the item or file around the clicked feature word determination operation indicator 204 is determined to be the item or file corresponding to the input feature word.

Or mode IV: the item or file is determined to be the item or file corresponding to the input feature word if the item or file is the nearest to the input field or on the prescribed (e.g. the upper or lower) location to the input field on the web page on which the feature word input field is located.

Or mode V: the only item or file on the web page with the feature input field is determined to be the item or file corresponding to the input feature word (classifier or key word).

Or mode VI: it is determined to be the item or file corresponding to the input feature word (classifier or key word) by the item or file which is the nearest to the list on the web page that the said list of the feature word (classification list or key word list) to be selected or on the prescribed location or direction (e.g., the left or right direction) of the list.

Or mode VII: the only item or file on the web page on which the list of the feature word (classification list or key word list) to be selected is determined to be the item or file corresponding to the input feature word (classifier or key word).

In fact, it can be arranged, as needed, for the order of the operation B and operation C as well as the operation rule of the terminal users.

The said list of the feature word (classification list or key word list) to be selected can be composed of many words being referred or selected when inputting the feature word (classifier or key word).

The list can be with a title like a “reference list” or a “classification list” or a “key word suggestion”.

In one embodiment, we can set the words like “recommended keyword:” or “selected classifier:” below each item to create an input field to benefit the user input. In order to avoid an error operation, the input field can be followed with the words “selection accomplishment” to confirm by clicking. Therefore, the user only need to input or “paste” in with the keyword or classifier in the input field of the corresponding item, and then click “selection accomplishment:” to accomplish the determination of the feature word of the file. This embodiment makes use of the said operation mode 3 and mode IV.

In another embodiment of this invention, there is the word “classification” (the feature word determination operation indicator) on the lower side or end of each item. After being clicked by a user, highest-layer classifiers of the list of the feature words to be selected would appear on one side of the web page. After the user clicking the classifier among them, there would be many classifiers belonging to the lower layer of the classification to be selected by the user. Analogically, when the user accomplishing selection and clicking the word “select”, each of the classifiers in the multi-layer classification of the item will be automatically input by the system. This embodiment makes use of the said operation mode 2 and mode III.

In the embodied implementation process, the operation mode 1 and mode I can also be used;

Or the operation mode 2 and mode II can also be used;

Or the operation mode 2 and mode VI can also be used;

Or the operation mode 2 and mode VII can also be used;

Or the operation mode 3 and mode III can also be used;

Or the operation mode 3 and mode V can also be used;

Or the operation mode 3 and mode VI can also be used;

Or the operation mode 3 and or mode VII can also be used, to determine the feature word or key word or classifier for the corresponding item in the item sequence or the corresponding file.

The present method is allowed providing a kind or many kinds or many suits of the feature word list or the keyword list or the classifier list (classification list or key word list) or multi-layer classifier list to be select for user terminals.

It can be generally acknowledged that the feature word of a certain item is the same or similar to the feature word of the file belonging to the item, the feature word of the file belonging to the item can be directly obtained according to the feature word of a certain item, or be determined in reverse.

Obviously, the input feature word in the present method is the determination information about the feature of the related item or file or the feature word corresponding to the feature inputted by clicking on the terminal from an operator.

The method can also include that the related computer system can be received or referred to or processed or denied with the feature determination opinion or feature word or classifier inputted by the terminal user.

Thus, it is the input that the feature word or keyword or classifier information of the related item or file by clicking on the terminal from an operator according to the operation A, B, C, namely, 504 “determining the feature word of the item or files according to the input”. The computer system or retrieval system can make use of this information directly, but may also need to process the input classification information.

Obviously, there is also a problem in the determination of the feature word for each file according to the clicking selection by Internet user: if there are different choices from the multiple users or terminal operators, what should to be done? That is the problem to be solved in “processing different input opinions” in the flow 505 in Figure.

When the retrieval system facing with the potential contradictory opinions input by the users or terminal operators to determine or input the feature word or classifier corresponding to any one item or file, the principles need to be followed can be at least considered about one or more of the following factors:

(1) The similarity between the title of the user who makes determination or the website URL and the topic of the file provider or author or its URL or the URL linking to the file; the more they like, the possibility of consistency between the user of classification selection and the provider of the original file is higher.

(2) The number of the users who made the same determination;

the higher the number of the users who made the same determination is, the more reliable the opinion is.

(3) The earlier or later for the time making a certain determination;

in order to form a classification index as quick as possible, it cannot be waited for too long; but the later revised opinion could be more cogent.

(4) The accuracy or score for the previous clicking selection from the user who makes determination or the same URL;

the opinion made by the users with high scores should be paid with more attention to.

(5) The consistency between the result of the selection by this kind of feature word and other artificial selection methods or computer selection methods or other selection system;

This will not only help you access to the existing achievement but also avoid changing too much.

(6) Whether the determination made by the retrieval system operator or staff or the like.

(7) Whether the user or the terminal who makes determination has registered in the website or web page which is relevant to the feature word determination or selection.

In fact, (1) or (6) or (7) can be given priority when needed and then consider other factors.

The formula for a certain objective function can also be edited, the variables of the function formula at least include one or more of the seven factors said above. The priority on the different classifications can be determined according to the objective function value.

The number of the feature words (especially the key words) for any one item or file might be high, the priority order of the feature words can be arranged by reference to the above factors and the highest number of the retained or provided feature words can be properly limited.

In fact, the classifier or feature word in the same layer or the classification selection for any one of the item or file is not necessary to be only one, it might be two or more, and have a priority order. It can limit the number of the classifier on each layer for any one item or file, for example, 5 or 6 or 8.

In the practice, a user who would like to determine the feature words or classification words of a file or an item may need to do multiple searches and determine on their own articles or interesting files to them. Therefore, the process from 501 to 505 needs to be repeated for several times. When the files which have been determined accumulate to a sufficient amount, applicable search tool setup can be proceeded with through this method. For an instance, we can create feature words index (classifier or key word index) or form new search modes so as to fundamentally improve search results in future. Furthermore, this method can also regard the feature words of one or more items or files or its consistency or discrepancy as the determinants for the rankings of files or items in search results.

For example, this method will encourage all network terminal users to include authors' names when they make determinations on searched files or items. As such, many files will be added with authors' information. Search engines can not only make files or items owned by hot authors or with hot feature words appear in former pages of search results, but it can also enable the files or items owned by different authors or with different feature words to appear and to be equally distributed in former pages of search results.

The method of this invention can also include 506 “forming the data, index for the feature word of files”: the retrieval system generates the database including the feature word content of multiple files or items or the database classified by the feature words or the classification by difference wholly or partly according to the data of the feature words (classifier or key word) corresponding to the multiple items or files determined by the said method, and generates the feature word index of the multiple files or items, which can be including: classifier index, classification index, keyword index, the feature word reversal index, keyword reversal index, classification reversal index, the item reversal index, etc. The reversal index is well known by people.

The said feature word index can refer to that by using the index, it can be retrieved or accessed to or linked to the file or its item or its address or its related information corresponding to the feature word according to any one of the selected feature words.

By the said feature word index (classifier or key word index), a computer retrieval system can provide the files or its items corresponding to the feature word according to the query of network terminal users.

It can be retrieved or accessed to or linked to the file or its item or its address or its related information corresponding to the classifier according to any one of the selected classifiers.

When needed, it can also be generated the classification database of the files or the items including multiple different subsets or multi-layer subsets or the multi-layer classification index according to each feature word or keyword or classifier of the item or file.

The method in the present method can also include: other original classifications or classification index for the multiple files can be replaced or revised by the classification or classification index for the feature word of the multiple file by using the method.

In the flow 504 or flow 506, it can be referred back (flow 510) to the flow 501 if the terminal user wishes to begin a feature word determination to other item or file.

Obviously, the purpose of this invention is not only to build a feature word database or feature word reversal index of related files, but it can also include performing item searching by using the index or data.

The present method can also include: when receiving a query, the retrieval system provides the retrieval or search result that is corresponding to the need of the feature word or classifier. The result can include an item (item of topic and abstract) or an item sequence or a list or a tree catalogue. An input field (305) can be set for input the query about classifier or key word (s) on the web page (FIG. 3 or FIG. 4) provided by computer retrieval system, for providing the search result that meeting the demand of the classifier(s) or key word.

The present method can also include:

The computer retrieval system provides the item sequence of multiple files to user terminals, there can respectively be the feature word indicator (301 or 304) for each of the item or the file belonging to the item around each of the item in part or whole of the said item sequence (flow 507).

The said feature word indicator can also be the key word indicator 301 related to the item or the belonging file (FIG. 3).

The feature word indicator of each item or the belonging file can be a single-layer or multi-layer classification indicator 401 (See in FIG. 4).

The classification indicators is the indicators of the classifiers or classification of the item. They are words or word graphic keys representing the classifications of the item. The so-called multi-layer classification indicators are suitable for many classifications which belong to the different layers of the classifications of the item or the belonging file.

Obviously, each classifier of the so-called multi-layer classifier indicators, no matter how big the classification is, it is the belonging classifier of the item or the belonging file. Thus when comparing with the generally displayed tree catalogue or the ordinary navigation list, there is not only a great decrease in the occupying space, but also a direct prompting and representative for the related items.

For example, a certain file or item belongs to the classifier “science”, in the next layer of sub-classification it belongs to the classifier “theory”, in the lower layer of sub-classification it belongs to the classifier “physics”. The words like “science, theory, physics” 401 around the item would be regarded as the indicators of multi-layer classifier.

The keyword in the said keyword indicator related to the item reflects the feature of content of the item or the belonging file.

There can be many methods to realize adding or displaying of the multi-layer feature word (or keyword or classification) indicator belonging to the item around the item. One is to make use of the address or URL of the belonging file corresponding to the item to access to the file, and further obtain the feature word (or keyword or classifier) information of the file (by using the result in 506), and add the word(s) around the original item. Another method is to directly display each item with the multi-layer feature word (or keyword or classifier) information of the original file when generating the item reversal index of the keyword or query word of the file with the feature word information of itself. Or other methods can be used.

We can make the feature word indicator around the said item link to the derivative item sequence of the other multiple file respectively 509. The feature word (or keyword or classifier) of the part or whole of the items of the linked derivative item sequence or the belonging file is the same to the feature word (or keyword or classifier) of the original indicator linked to the sequence, and can be or not be in accordance with the query request provided by the original user.

When needed, for example, the derivative item sequence of the files that belongs to the feature word and corresponds to the query request by the original user can be obtained when the search user clicking a certain feature word indicator in the multiple indicators to be selected (flow 509), thus the searching area can be greatly reduced or freely controlled to obtain the query result and the demanded file.

Obviously, around the said new obtained item in the derivative item sequence of the file corresponding to the feature word, there can also be the multiple different feature words indicators (or classification indicators or keyword indicators) belonging to the item or the belonging file simultaneously, it can also be made that the multiple feature word indicator (or classifier indicator or keyword indicator) belonging to the file which belongs to the item links to the other derivative sequences of the multiple item related to these indicators, and the rest may be deduced by analogy.

Sometimes, there might be a multi-layer classification list (e.g., the international classification list for patent literature) in a specific scope in the existing retrieval technologies, but the unprofessional ordinary user usually cannot grasp the meaning or the exact covering scope of each classifier and make the wrong selection of classification, which affects the retrieval speed.

Some search engine systems provide the indicator e.g. “the similar web page” or “the same website” and the like at the end of the item for the search result, but the obtained result is too general and disordered, and the usage is very limited.

However, the method of this invention, which simultaneously displays the indicator of the multiple feature word around the provided item when queried, can bring great convenience to the query maker. When the user found the interested item, if he or she wants to obtain a sequence of items belong to the higher layer classification of the interested item, the higher layer feature word or classifier (e.g. “science” in the previous illustration) in the indicators can be clicked; if he or she wants to obtain a sequence of items belong to the lower layer classification of the interested item, the lower layer feature word or classifier (e.g., “physics” in the previous illustration) in the indicators can be clicked directly. Therefore, the accuracy and flexibility of the clicking selection by the query maker can be maintained meanwhile. The query efficiency and query experience can be improved.

The linkage between the said classifier indicator or keyword indicator and the new derivative item sequence in the present invention can be a direct linkage or an indirect linkage 509.

The said indicator can firstly be linked to the query search in which added the feature word (or the corresponding classifier or the keyword) in the indicator as a query word to the original query word, and thus obtain the demanded sequence.

The said indicator can firstly be linked to the query search, which regard the feature word or corresponding classifier or keyword in the indicator as the query logical requirement further on the basis of the original query, and thus obtain the demanded item sequence.

When needed, the item(s) presented in the original query result sequence while not presented in the said derivative item sequence can be arranged to follow the said derivative item sequence.

It can be arranged that, when needed: around the item sequences of the multiple files provided by the computer retrieval system to the user terminal according to the query request submitted by the network query user, there is a navigation list composed by the multiple feature word indicators (flow 508), each of the feature word indicators can link to a different derivative item sequence of multiple files respectively.

Namely, if the user clicking a certain feature word in the list when searching (it can be arranged as needed to re-clicked the “search” or “confirm” or the operation key with other titles), the new derivative item sequence corresponding to the feature word would be obtained 509, the feature word of the file belonging to the item in the sequence is the same to the feature word in the original indicator (the clicked) linked to the sequence, and can be in accordance with the original query request from the user or not.

The said navigation list can be a one layer list or a multi layer list. It can be allowed to automatically display multiple feature word indicators in the next layer to be selected after determining the selection of the feature word of the upper layer of the list.

The said feature word indicator of the navigation list can be a classifier indicator or a keyword indicator.

The linking between the feature word indicator of the said navigation list and the new item sequence can be a direct linking or an indirect linking.

The said indicator can firstly be linked to the query search, which add an indicator demand for the keyword in the indicator on the basis of the original query word, and thus obtain the demanded item sequence. The said indicator can firstly be linked to the query search, which regard the feature word in the indicator as the query logical requirement further on the basis of the result of the item sequence searching of the original query, and thus obtain the demanded item sequence. When needed, the item in the original item sequence while not presented in the item of the new item sequence can be arranged to follow the new item sequence. When needed, the flow 507 or 508 can be repeated on the item sequence of the flow 509 to make it has the corresponding feature word indicator or navigation list to link or display the updated result of the item sequence by clicking.

When accomplishing the search, the searcher can return (flow 510) to begin the operation again.

The above content is the illustrative description for the method in this invention, which cannot be used to limit the claims scope of this invention.

What is claimed is:

1. A method of enhancing search results using multi-level classification information, comprising:
determining multi-level classification information associated with a plurality of data items based at least in part on one or more user inputs and one or more predetermined rules;
generating a database, wherein the database comprises the plurality of data items and the multi-level classification information associated with the plurality of data items.
retrieving, from the database, at least one of the plurality of data items associated with a search request and multi-level classification information associated with the at least one of the plurality of data items; and
generating at least one search results page, wherein the at least one search results page comprises the at least one of the plurality of data items and one or more multi-level classification information indicators associated with each of the at least one of the plurality of data items, wherein each indicator is linked to one or more derivative data items that include corresponding classification information.

2. The method of claim 1, wherein the multi-level classification information associated with the plurality of data items comprises hierarchical classification levels of the plurality of data items.

3. The method of claim 1, wherein the one or more multi-level classification information indicators associated with each of the at least one of the plurality of data items are displayed proximate to a corresponding data item on the at least one search results page.

4. The method of claim 1, wherein the one or more predetermined rules comprise one or more of: (1) a relationship between a user providing a user input and a creator of a corresponding data item; (2) a number of users that provide a similar user input; (3) a time when a user input is made; (4) an accuracy assessment of previous user inputs provided by a certain user or URL; (5) a consistency between a user input and a classification determination made by other methods; (6) whether a user input is from a person who maintains the multi-level classification information or the database; or (7) whether a user or terminal that gives a user input has registered in a website associated with an implementation of the method.

5. The method of claim 1, further comprising:
presenting one or more derivative data items that include corresponding classification information in response to selecting a multi-level classification information indicator among the one or more multi-level classification information indicators associated with each of the at least one of the plurality of data items.

6. The method of claim 1, wherein the at least one search results page further comprises a navigation list including a plurality of classification information indicators, wherein each of the plurality of classification information indicators links to one or more derivative data items, and wherein at least some of the derivative data items associated with each of the plurality of classification information indicator comprise corresponding classification information.

7. The method of claim 6, wherein each of the plurality of classification information indicator corresponds to a highest level of classification information associated with the plurality of data items.

8. The method of claim 7, further comprise:
displaying one or more corresponding lower levels of classification information in response to a selection of a classification information indicator among the plurality of classification information indicator in the navigation list.

9. The method of claim 6, wherein the navigation list comprises a hierarchy of classification associated with the plurality of data items.

10. A system of enhancing search results using multi-level classification information, comprising, comprising:
at least a processor; and
at least a memory communicatively coupled to the at least a processor to configure the at least a processor to:
determine multi-level classification information associated with a plurality of data items based at least in part on one or more user inputs and one or more predetermined rules;
generate a database, wherein the database comprises the plurality of data items and the multi-level classification information associated with the plurality of data items.
retrieve, from the database, at least one of the plurality of data items associated with a search request and multi-level classification information associated with the at least one of the plurality of data items; and
generate at least one search results page, wherein the at least one search results page comprises the at least one of the plurality of data items and one or more multi-level classification information indicators associated with each of the at least one of the plurality of data items, wherein each indicator is linked to one or more derivative data items that include corresponding classification information.

11. The system of claim 10, wherein the multi-level classification information associated with the plurality of data items comprises hierarchical classification levels of the plurality of data items.

12. The system of claim 10, wherein the one or more predetermined rules comprise one or more of: (1) a relationship between a user providing a user input and a creator of a corresponding data item; (2) a number of users that provide a similar user input; (3) a time when a user input is made;
(4) an accuracy assessment of previous user inputs provided by a certain user or URL; (5) a consistency between a user input and a classification determination made by other methods; (6) whether a user input is from a person who maintains the multi-level classification information or the database; or (7) whether a user or terminal that gives a user input has registered in a website associated with an implementation of the method.

13. The system of claim 10, the at least a memory further configuring the at least a processor to:
present one or more derivative data items that include corresponding classification information in response to selecting a multi-level classification information indicator among the one or more multi-level classification information indicators associated with each of the at least one of the plurality of data items.

14. The system of claim 10, wherein the at least one search results page further comprises a navigation list including a plurality of classification information indicators, wherein each of the plurality of classification information indicators links to one or more derivative data items, and wherein at least some of the derivative data items associated with each of the plurality of classification information indicator comprise corresponding classification information.

15. The system of claim 14, wherein each of the plurality of classification information indicator corresponds to a highest level of classification information associated with the plurality of data items.

16. The system of claim 15, the at least a memory further configuring the at least a processor to:
display one or more corresponding lower levels of classification information in response to a selection of a classification information indicator among the plurality of classification information indicator in the navigation list.

17. A non-transitory computer-readable storage medium bearing computer-readable instructions that upon execution on a computing device cause the computing device at least to:
determine multi-level classification information associated with a plurality of data items based at least in part on one or more user inputs and one or more predetermined rules;
generate a database, wherein the database comprises the plurality of data items and the multi-level classification information associated with the plurality of data items.
retrieve, from the database, at least one of the plurality of data items associated with a search request and multi-level classification information associated with the at least one of the plurality of data items; and
generate at least one search results page, wherein the at least one search results page comprises the at least one of the plurality of data items and one or more multi-level classification information indicators associated with each of the at least one of the plurality of data items, wherein each indicator is linked to one or more derivative data items that include corresponding classification information.

18. The non-transitory computer-readable storage medium of claim 17, wherein the multi-level classification information associated with the plurality of data items comprises hierarchical classification levels of the plurality of data items.

19. The non-transitory computer-readable storage medium of claim 17, wherein the one or more predetermined rules comprise one or more of: (1) a relationship between a user providing a user input and a creator of a corresponding data item; (2) a number of users that provide a similar user input; (3) a time when a user input is made; (4) an accuracy assessment of previous user inputs provided by a certain user or URL; (5) a consistency between a user input and a classification determination made by other methods; (6) whether a user input is from a person who maintains the multi-level classification information or the database; or (7) whether a user or terminal that gives a user input has registered in a website associated with an implementation of the method.

20. The non-transitory computer-readable storage medium of claim 17, further comprising computer-readable instructions that upon execution on the computing device cause the computing device at least to:
present one or more derivative data items that include corresponding classification information in response to selecting a multi-level classification information indicator among the one or more multi-level classification information indicators associated with each of the at least one of the plurality of data items.
